(19) United States
(12) Patent Application Publication
(10) Pub. No.: US 2025/0016322 A1
(43) Pub. Date: Jan. 9, 2025

(54) SYSTEM AND METHOD FOR OPTIMIZING BILL OF MATERIAL COST AND POWER PERFORMANCE FOR DRONES

(71) Applicant: TriSpace Technologies (OPC) Pvt Ltd., Bengaluru (IN)

(72) Inventors: Narasimhan Vijay Anand, Bengaluru (IN); Chandana M S, Bengaluru (IN); Kamarsu Venkata Sriya, Bengaluru (IN); Mohammed Amrin Bushra Taj, Bengaluru (IN); Akshay Madavalappil Ramesh, Bengaluru (IN); Lellapalli Anagha, Bengaluru (IN)

(21) Appl. No.: 18/358,543

(22) Filed: Jul. 25, 2023

(30) Foreign Application Priority Data
Jul. 3, 2023 (IN) 202341044376

(51) Int. Cl. H04N 19/127; H04N 19/11; H04N 19/172; H04N 19/42; H04N 19/593

(52) U.S. Cl. CPC H04N 19/127; H04N 19/11; H04N 19/172; H04N 19/42; H04N 19/593

(57) ABSTRACT

The present invention provides a system and method for optimizing BoM cost and power performance drones. The system (100) comprises dual CPU cores with Single Instruction Multiple Data (SIMD) instruction set but the instructions lack saturation logic (101), wherein control software modules is implemented. Video codec encoder modules (102) are implemented in the second CPU with SIMD instruction set lacking saturation logic. Removing the logic hardware used to implement saturation in the SIMD instructions helps in lowering the BoM cost and the inventive steps helps in achieving bit-exact results without saturation logic. The power consumed using CPU without saturation logic in SIMD instruction is lesser than using Digital Signal Processing Instruction Set Architecture with saturation logic, thus giving value additions to platform SoC designers and makers for using low BoM cost solution with better power performance.

### CROSS-REFERENCE TO RELATED APPLICATIONS

The present application claims priority to Indian patent application serial no. IN 202341044376, filed Jul. 3, 2023, herein incorporated by reference in its entirety.

### FIELD OF THE INVENTION

The present invention relates to a system and method for optimizing Bill of Material (BoM) cost and power-performance for Drones. More specifically, the present invention relates to optimizing BoM cost of platform System-On-Chip (SoC) used in Drones. Video codec encoder with coding tools customized for video surveillance use case in drone is implemented on a Central Processing Unit (CPU) with Single Instruction Multiple Data (SIMD) instructions without saturation logic hardwired in the SIMD instructions and control software executing in another CPU on the platform SoC for autonomous flight navigation.

### BACKGROUND OF THE INVENTION

Platform SoC typically consists of CPU(s) cores, DSP(s) cores, and a GPU core. Platform SoC is used in building different kind of handheld gadgets such as Mobile handsets, Drones, Battery management system, and so on. Compute intensive video codecs are implemented on the DSP(s) sometimes assisted with a hardware co-processor.

Due to high battery power consumption in some of the coding tools used in video compression such as Motion estimation/compensation and in-loop filtering, we build a customized video encoder solution devoid of computationally intensive modules Motion estimation/compensation and in-loop deblocking filter. As a result, the coding tools are based intra frame coding.

For such a customized video encoder, we use CPU core with SIMD instructions lacking saturation logic instead of a DSP core. The DSP core with its rich instruction set architecture (ISA) uses far more logic gates and greater chip area than a CPU.

Having a CPU core ISA with only SIMD extensions and lacking saturation logic except for three instructions namely ADD, SUB and a dedicated SAT instruction, the BoM cost of resulting CPU core is much lesser than DSP core. Getting bit-exact results and power optimal solution on CPU with this SIMD instruction without saturation logic is challenging. This invention achieves results of implementing video codec encoder on CPU whilst achieving better power performance and lowering BoM.

The U.S. patent document U.S. Pat. No. 11,330,526 titled “System and method for optimizing power consumption in video communication in mobile devices” discloses a method and apparatus for optimizing power consumption in mobile devices by suitable Instruction Set Architectural feature changes and optimal implementation of video codecs. However, the solution is aimed at power optimization of the video call use case using CPU and DSP cores and all the coding features tools available in video encoding.

### SUMMARY OF THE INVENTION

The present invention overcomes the drawbacks in the prior art and provides a system and method for optimizing BoM cost and power-performance of platform SoC for drones.

The system comprises dual CPU core in the platform SoC, one is used for autonomous flight control and other used for recording video. Digital video data of resolution 8 bits, 10 bits, is provided to the CPU for encoding. The control software is implemented on the CPU while computationally intensive encoder modules are implemented in another CPU.

In an embodiment of the invention, digital video signal is encoded using coding tools from video compression standards. The encoding tools such as Motion Estimation, Motion Compensation, and in-loop filtering are not used due to high battery power consumption. Only Intra Frame based coding tools are used and implemented in the CPU having SIMD instruction without saturation logic. The current consumption in the CPU is less than the case all coding tools are used or when DSP core with saturation logic built in the ISA, and has added advantage of lowering BoM cost of platform SoC for Drones.

Thus, the present invention provides method to optimize the BoM cost of platform SoC for drone while saving power consumption in using Drone. Using a CPU core for encoding video instead of DSP core saves chip area and thereby reducing BoM cost of platform SoC for drones.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram of a system for implementing autonomous navigation flight software in a CPU in the platform SoC and video encoder in another CPU of the platform SoC, according to one embodiment of the invention.

FIG. 2 illustrates method for optimizing BoM cost of platform SoC for drones, according to one embodiment of the invention.

FIG. 3 illustrates method for optimizing BoM cost of platform SoC for drones whilst implementing video encoder in the platform SoC, according to one embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

In order to more clearly and concisely describe and point out the subject matter of the claimed invention, the following definitions are provided for specific terms, which are used in the following written description.

The present invention provides a system and method for optimizing BoM cost and power-performance of platform SoC for drones. The system comprises dual CPU core wherein, all control software needed for autonomous flight navigation is implemented on one CPU. The video encoder is implemented on another CPU. The implementation of video encoder modules in CPU with SIMD instruction without saturation logic instead of in DSP core results in up-to several thousand logic gates reduction in platform SoC.

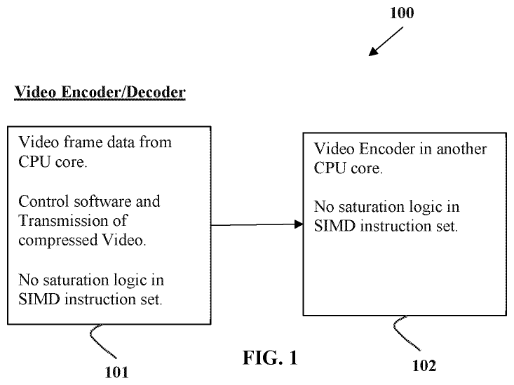

FIG. 1 illustrates a block diagram of a system for implementing autonomous navigation flight and video encoder in platform SoC for drones, according to one embodiment of the invention. In a preferred embodiment, the system comprises a CPU core (101) which is tasked with control software for control code and autonomous navigation flight. The encoder module is implemented on another CPU with SIMD instructions without saturation logic built (102).

Only the coding tools of the digital video compression standard Intra frame coding namely transform, quantization and run length encoding using variable length codes is implemented on the CPU. The current consumption in the SoC is reduced while reducing BoM cost (102) compared to an implementation on a DSP core.

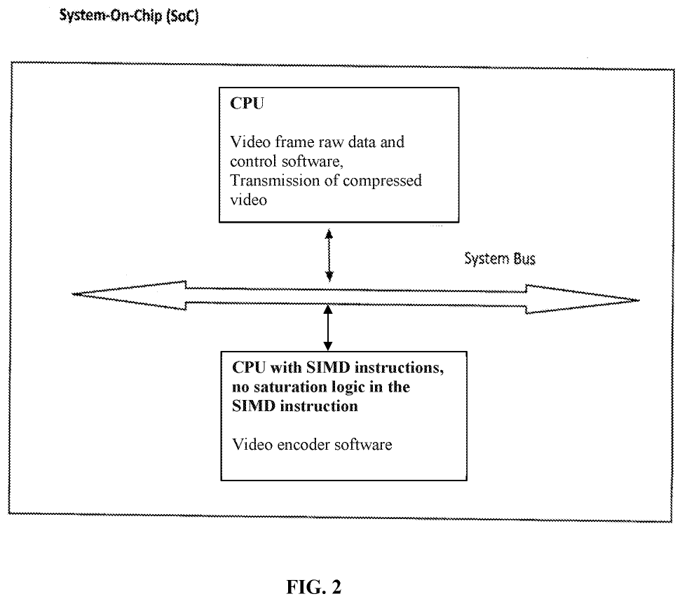

FIG. 2 In an embodiment of the invention, the implementation of video encoder customized for drone use case on CPU core results in efficient implementation of video encoder reducing the current consumption and BoM cost of platform SoC. The Architecture of the SoC contains dual CPU cores instead of a CPU and DSP. Thus, lower BoM cost platform SoC is built while still providing better power consumption in the platform SoC for drones.

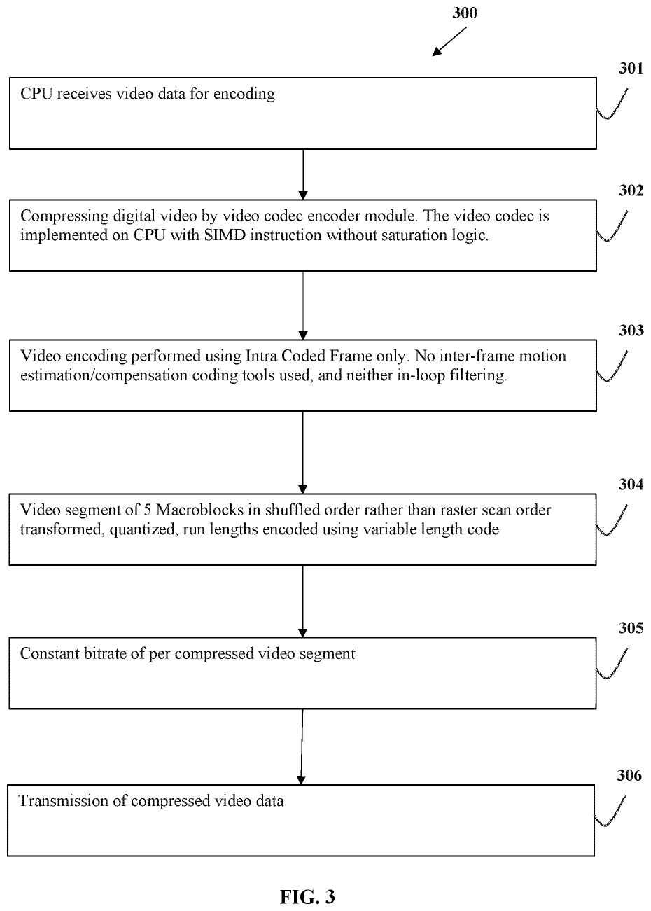

FIG. 3 illustrates the method for optimizing power consumption in video encoder modules in the CPU, according to one embodiment of the invention. In a preferred embodiment, the method initiates with the step of receiving raw video at step 301.

At step 302, video frame samples are encoded by a video codec encoder module. The video encoder module is implemented on CPU with SIMD instructions without saturation logic. The coding tools involving Intra frame type are only implemented at step 303. Inter frame coding tools and in-loop deblocking filter are not implemented. The current consumption in running the encoder is lower compared to implementation using all the coding tools, and achieving bit-exact results overcoming the limitation of lack of saturation logic in the instructions.

At step 304, The macroblocks are not processed raster scan order but processed in shuffled order. Group of five Macroblocks undergoes transform, quantization and run length encoding using VLC (102).

At step 305, Constant bitrate for a group of five Macroblocks in shuffled order is achieved (102).

The inventive step in encoder module implemented on CPU with SIMD instructions is described now. The video frame samples are 8 bits. In intra frame type coding type, the block sizes are fixed to 8×8. The input to transform module is thus 8 bits. The transform module is implemented so as to ensure intermediate and output results doesn't cross 16-bit span. Thus, saturation can be turned off and MAC instruction without saturation embedded is useful and SIMD optimization is possible. No inter frame coding tools Motion estimation and compensation are used as also no in-loop deblocking filter is used. Thus, saturation can be turned off, enabling Instruction Set Architecture (ISA) to have MAC without saturation embedded in the instruction and SIMD optimization is possible, thus saving Bill of Material (BOM) cost and giving power savings in optimization, thus saving Bill of Material (BOM) cost and giving better power performance than using a DSP core.

Thus, the present invention provides a method to optimize the BoM cost of platform SoC for drones.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

We claim:

1. A system (100) for optimizing Bill of Material (BoM) cost and power performance for Drones, the system (100) comprising:
a. a Central Processing Unit (CPU) core for executing control code for autonomous navigation flight of drone (101);
b. video codec encoder modules (102), wherein the video codec encoder modules are implemented in another CPU core with Single Instruction Multiple Data (SIMD) instructions;
c. Only Intra frame coding type used without any in-loop deblocking filter, Macroblocks are processed in shuffled order and not in raster scan order to produce constant bitrate for a unit of five Macroblocks;
d. saturation is turned off in the video codec encoder; and
e. the Arithmetic Logic Unit (ALU) of CPU is designed to have SIMD instructions without saturation logic in the critical instructions, wherein the critical instruction include but not limited to Multiply and Accumulate (MAC) and shift instructions.

2. The system as claimed in claim 1, wherein the BoM cost of platform SoC is reduced compared to using a Digital Signal Processor (DSP) core to implement video codec modules.

3. A method for optimizing BoM cost and power performance for Drones, the method comprising the steps of:
a. executing control code for autonomous flight in a CPU core (101);
b. implementing video codec encoder (102) in a CPU core with SIMD instruction;
c. Only Intra frame coding type used without any in-loop deblocking filter, Macroblocks are processed in shuffled order and not in raster scan in order to produce constant bitrate for a unit of five Macroblocks;
d. saturation is turned off in the video codec encoder; and
e. the ALU of CPU is designed to have SIMD instructions without saturation logic in the critical instructions, wherein the critical instruction include MAC and shift instructions.
